(19) United States
(12) Patent Application Publication
(10) Pub. No.: US 2015/0006367 A1
(43) Pub. Date: Jan. 1, 2015

(54) SYSTEMS AND METHODS FOR OBSCURING FINANCIAL DATA

(71) Applicant: Toshiba Global Commerce Solutions Holdings Corporation, Tokyo (JP)

(72) Inventors: Columbus Brown, Wake Forest, NC (US); Brian Weischedel, Raleigh, NC (US)

(73) Assignee: Toshiba Global Commerce Solutions Holdings Corporation, Tokyo (JP)

(21) Appl. No.: 14/175,814

(22) Filed: Feb. 7, 2014

Related U.S. Application Data
(60) Provisional application No. 61/840,430, filed on Jun. 27, 2013.

(51) Int. Cl. G06Q 20/38

(52) U.S. Cl. CPC G06Q 20/383
USPC 705/39

(57) ABSTRACT

Systems and methods for obscuring payment card industry (PCI) data are disclosed. According to an aspect, a method includes receiving a file including first and second financial numbers. The method also includes compressing the second financial number. Further, the method includes determining a link for addressing the first financial number. The method also includes replacing the second financial number in the file with the compressed, second financial number and the link.

### CROSS REFERENCE TO RELATED APPLICATION

This application claims the benefit of U.S. Provisional Patent Application No. 61/840,430, filed Jun. 27, 2013 and titled SYSTEMS AND METHODS FOR OBSCURING PAYMENT CARD INDUSTRY (PCI) DATA, the content of which is hereby incorporated herein by reference in its entirety.

### TECHNICAL FIELD

The present subject matter relates to retail systems. More particularly, the present subject matter relates to systems and methods for obscuring financial data.

### BACKGROUND

Retailers process many purchase transactions per day. Such transactions may include processing credit cards, debit cards, and gift cards. A requirement for doing so is compliance with the payment card industry data security standard (also known as “PCI DSS,” or simply “PCI”). Ensuring that a retailer's payment processing computers, cash registers, back office servers, and credit card terminals comply with PCI can be time consuming and expensive. Various technical and non-technical standards and practices must be abided by for PCI compliance. The retailer can be subject to frequent assessments and auditing for PCI compliance.

Machine or memory dumps at point of sale (POS) systems can sometimes contain sensitive PCI information such as credit card or debit card numbers. Even if an application immediately encrypts, wipes, or obscures numbers in their possession, the card number could be in the operating system (OS) buffers or other areas the application cannot access. It is desired to prevent unauthorized access to these numbers. Unauthorized individuals can scan the dump and identify strings of numbers that appear to be valid card numbers. These can be numbers that follow that appear to follow PCI guidelines and pass the Luhn digit check.

One technique for preventing unauthorized access is to overwrite card numbers with a pattern, such as *PCI*. A potential problem with this technique is that not all strings of digits that follow these rules are actually card numbers, thus many false positives can be generated that were never used with payment cards. This can interfere with problem determination.

Another technique for preventing unauthorized access is use of encryption. However, this requires both sides to exchange keys (e.g., using asymmetric encryption with a private key held by the team receiving the dump and a public key used in the retail store; the public key or fingerprint can be sent along with the dump as an aid in identifying the private key to use to decrypt the data). The complexity of key generation and management and increased CPU utilization can be a significant drawback to use of encryption. In order to be useful, the data must be fully decrypted before use and cannot be directly used by automated processing routines.

In view of the foregoing, there is a need for improved techniques for managing PCI data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for obscuring financial data. The present subject matter involves obscuring the financial data, such as PCI data, at the location of one party. Subsequently, a recipient party can reverse the process to recover the financial data. Information needed to recover the original contents data may be stored with the modified data or transmitted separately. A party that knows the algorithm can still recover the original data, but the card numbers can be protected from casual viewing. This technique can maintain the speed of wiping the data and avoids key management. In addition, since most of the data is unchanged, it allows the files to be viewed with a dump viewer, such as the GNU debugger (gdb) on the LINUX® operating system or the Windows debugger (WinDbg) on the Microsoft WINDOWS® operating system, in many cases without using a recovery process. Further, the technique may be implemented without writing the unobscured data to disk.

According to an aspect, a method includes receiving a file including first and second financial numbers. A file in this case may be a collection of related data (bytes) that are stored and operated on as a single entity. The file does not necessarily have to be stored in the file system of a computing device. The method may also include compressing the second financial number. Further, the method includes determining a link for addressing the first financial number. The method also includes replacing the second financial number in the file with the compressed, second financial number and the link.

### BRIEF DESCRIPTION OF THE DRAWINGS

The foregoing summary, as well as the following detailed description of various embodiments, is better understood when read in conjunction with the appended drawing. For the purposes of illustration, there is shown in the drawings exemplary embodiments; however, the presently disclosed subject matter is not limited to the specific methods and instrumentalities disclosed. In the drawing:

FIG. 1 is a block diagram of a POS system configured to obscure financial data in accordance with embodiments of the present invention;

FIG. 2 is a flow chart of an example method for obscuring financial data in accordance with embodiments of the present disclosure; and

FIG. 3 is a diagram of an example method for obscuring financial numbers within a file in accordance with embodiments of the present subject matter.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

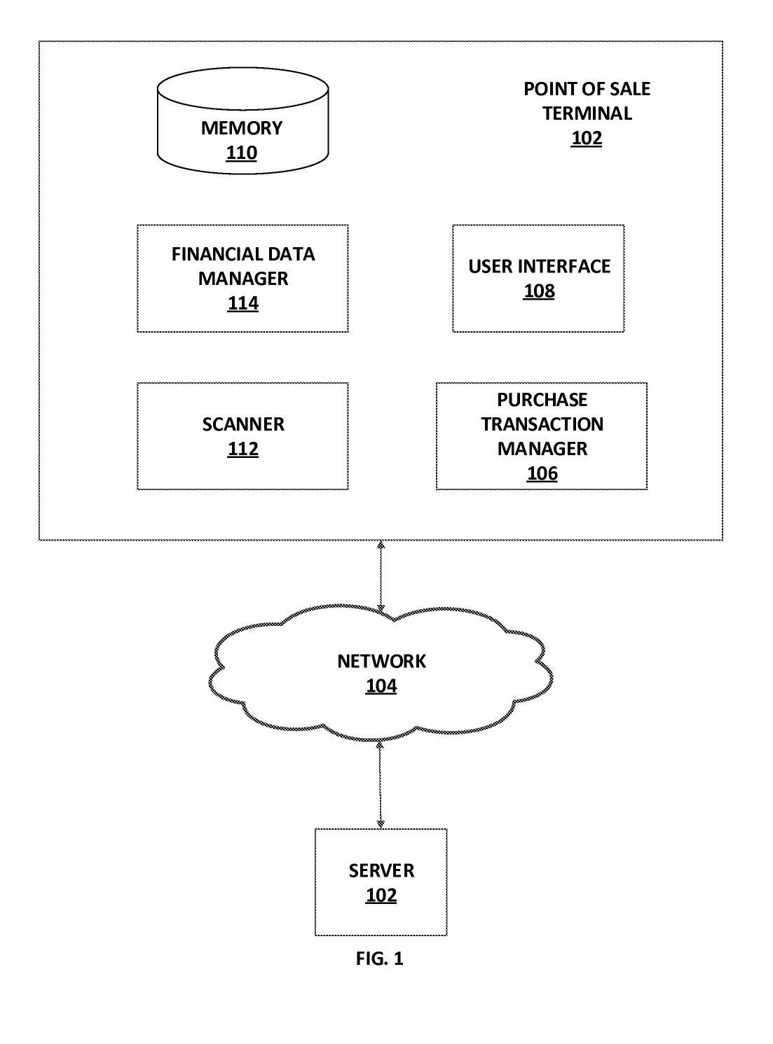

FIG. 1 illustrates a block diagram of a point of sale (POS) system configured to obscure financial data in accordance with embodiments of the present invention. The POS system may be located within a retail environment, such as a “brick-and-mortar” store, for implementing shopper checkout and purchase transaction services. Referring to FIG. 1, the POS system may include a POS terminal 100. The POS terminal 100 may be in wired or wireless communication with a server 102 via a network 104. The network 104 may include any suitable type of network such as, but not limited to, wireless, wireline, or combinations thereof. For example, the network 104 may include, but is not limited to, a LAN, wide area network (WAN), Internet, and the like. The POS system may include one or more other POS terminals and/or computing devices (not shown) configured to implement functions for obscuring financial numbers in the same or a similar manner to the POS terminal 100.

The POS terminal 100 may include a purchase transaction manager 106 configured to implement functions for conducting a purchase transaction with a shopper. For example, the POS terminal may include a user interface 108 configured to interact with one or more users, such as retail personnel and shoppers. For example, the user interface 108 may include a display (e.g., a touchscreen display), a keyboard, and/or the like for presenting information and/or graphics and for receiving input from a user. The purchase transaction manager 106 may include hardware, software, firmware, or combinations thereof. For example, the purchase transaction manager 106 may include one or more processors (not shown) and memory 110. The server 102 may provide management and pricing information for purchasing items or products scanned by a scanner 112 at the POS terminal 100. In an example, retail personnel or a shopper may scan an item for purchase using the scanner 112. For example, the scanned information may include universal product code (UPC) information. The purchase transaction manager 106 may use the UPC information to search a UPC database for the UPC information for return of a price for the item. The UPC database may reside in the memory 110 or at the server 102. These and other functions may be performed by the POS terminal 102 or by a combination of the POS terminal 102 and the server 102.

The user interface 108 may include a keypad device that enable a shopper to enter account and payment information for processing by the purchase transaction manager 106 of the POS terminal 102. The keypad device may enable a shopper to enter a personal identification number (PIN) if using a debit card. The user interface 108 may include a display for displaying purchase and transaction information to the shopper. For example, the user interface 108 may be a touchscreen display for displaying text and graphics and for receiving user input. The user interface 108 may be communicatively coupled to the POS terminal 102 via wireless or wireline elements.

The user interface 108 may include a financial card scanner configured to read a financial number from a financial card. Example financial cards include, but are not limited to, credit cards, debit cards, loyalty cards, and the like. During a purchase transaction, a financial card of the shopper may be read by the scanner to obtain a financial card number stored on a magnetic stripe or otherwise on the card. The financial card number may be used for purchase of one or more items by the shopper.

Financial card numbers obtained by scanning or by other processes may be stored in a memory of a POS terminal, a server, or other computing device. These financial numbers or other information may be obscured by a POS terminal or other computing device in accordance with embodiments of the present invention. As an example, a POS terminal may include one or more files that each contain multiple financial numbers (e.g., credit card numbers, debit card numbers, and loyalty card numbers). According to embodiments, the present disclosure can include encrypting just the financial numbers within a file without disrupting the rest of the data in the file. This allows the file to have a good probability of being useful for problem determination without being decrypted. The algorithm can take advantage of the fact that potential card numbers can be determined by inspection and is also easily compressible.

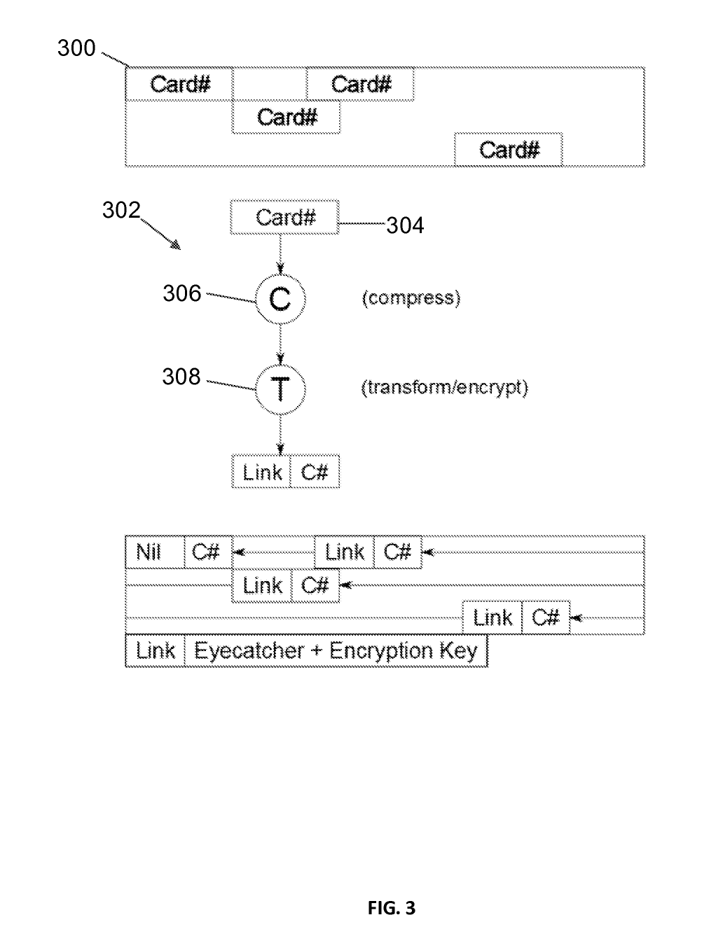

It is noted that a financial card number can include 15-16 digits in binary, ASCII, or BCD format. To be a valid card number, these digits just also pass the Luhn algorithm check. A program can scan the file looking for sequences of digits that pass this check and treat them as financial card numbers (designated “Card #” in FIG. 3). The digits in the card number may be in any other suitable formats (e.g., Unicode). Also, the digits in the card number may be presented in a non-contiguous manner. For example, the numbers may be separated by dashes or any other suitable type of character.

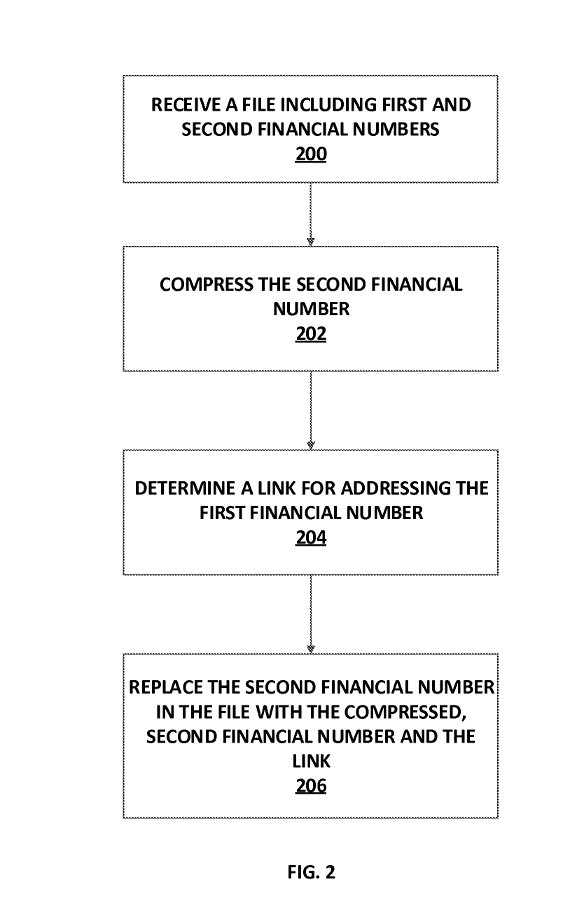

FIG. 2 illustrates a flow chart of an example method for obscuring financial data in accordance with embodiments of the present disclosure. This example method is described as being implemented by the system shown in FIG. 1, but it should be understood that the method may be implemented by another other suitable system or computing device. Referring to FIG. 2, the method includes receiving 200 a file including first and second financial numbers. For example, referring to FIG. 1, the memory 110 may store multiple financial numbers obtained from financial cards of shoppers conducting purchase transactions. The first and second numbers may include all of the numbers of a financial card. Thus, the financial card may include a financial number having different subsets of numbers. The financial card numbers may be suitably stored in the memory in a file.

The method of FIG. 2 includes compressing 202 the second financial number. Continuing the aforementioned example, the financial data manager 114 may retrieve a financial card number from the memory 110. Further, the financial data manager 114 may compress a subset of the numbers within the financial card numbers. For example, a 6 digit number within a financial card number may be converted to a binary representation or compressed in any other suitable manner.

The method of FIG. 2 includes determining 204 a link for addressing the first financial number. Continuing the aforementioned example, bits remaining in the stored financial number may be used to store the difference between a current location in the file and a prior obscured location (referred to as a “link”). The method may include replacing 205 the second financial number in the file with the compressed, second financial number and the link. In this way, the data in the file is obscured while also providing information in the link for addressing or otherwise accessing the information.

FIG. 3 illustrates a diagram of another example method for obscuring financial numbers within a file in accordance with embodiments of the present subject matter. Referring to FIG. 3, a file 300 includes multiple credit card numbers. The file 300 may be stored on or generated at the POS system.

Per PCI security guidelines, the first 6 digits (bank identifier) and last 4 digits of a card number do not have to be secured (the last 4 are typically printed on a receipt). This leaves 5 to 6 digits in the middle that may be obscured. In the examples provided herein, it is assumed that 6 digits are obscured, but it should be understood that any suitable number of digitals may be obscured. Each of these digits may have over 2.5 bits of information that can be stored in 6 bytes (48 bits). Specifically, these 6 digit number can be converted from their decimal to binary representation using 20 bits. Now, referring to the flow diagram 302, each card number 304 may be compressed in this manner (step 306).

The method may also include further obscuring the card number with encryption (step 308). The now encrypted card number (designated “C #” in FIG. 3) is placed back into the file. The remaining 28 bits (of the original 48) can then be used to store the difference between the current location in the file and the prior obscured location (designated “Link” in FIG. 3). When the algorithm is done, it can write a few extra bytes or other suitable notification to the end of the file to indicate that card data has been obscured (designated “Eyecatcher” in FIG. 3) and to indicate the last location obscured (designated “Link” in FIG. 3). If the file has a fixed format that does not allow for extra data to be appended at the end, the extra bytes can be stored separately or placed into the file at another identifiable location (in a section reserved or created for this data).

If the data was encrypted the public key or fingerprint of the key used may also be appended to the file (designated “Encryption Key” in FIG. 3). In practice, if the files are large enough that a 28 bit offset would be insufficient, more bytes may be needed by this algorithm. In addition, it may be possible that a given compressed/encrypted card number and link value can produce a string of numbers that still matches the Lunh algorithm. To ensure that a PCI scan does not see the obscured data as a card number, the high bit of one of the bytes may be set (making the value a non-number).

If the original file data needs to be recovered for more in depth problem determination, a tool may be used to reverse the transformation above. The tool may use the encryption key if the data were encrypted. It is noted that the card number may be of any 3 different types (binary, ASCII, or BCD) as described above. Once the number is converted to binary, the type information is “lost”. Instead of using 2 bits to store the type indicator, during recovery the type of card number is inferred from the preceding digits.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
receiving a file including first and second financial numbers;
compressing the second financial number;
determining a link for addressing the first financial number; and
replacing the second financial number in the file with the compressed, second financial number and the link.

2. The method of claim 1, wherein the financial numbers are financial card numbers.

3. The method of claim 1, wherein the financial numbers are credit card numbers.

4. The method of claim 1, further comprising encrypting the second financial number.

5. The method of claim 1, further comprising adding, to the file, a notification of obscured financial numbers.

6. The method of claim 1, further comprising compressing and encrypting the first financial number.

7. A system comprising:
at least a processor and memory configured to:
receive a file including first and second financial numbers;
compress the second financial number;
determine a link for addressing the first financial number; and
replace the second financial number in the file with the compressed, second financial number and the link.

8. The system of claim 7, wherein the financial numbers are financial card numbers.

9. The system of claim 7, wherein the financial numbers are credit card numbers.

10. The system of claim 7, wherein the at least a processor and memory are configured to encrypt the second financial number.

11. The system of claim 7, wherein the at least a processor and memory are configured to add, to the file, a notification of obscured financial numbers.

12. The system of claim 7, wherein the at least a processor and memory are configured to compress and encrypt the first financial number.

13. A computer program product comprising a computer readable storage medium having program instructions embodied therewith, the program instructions executable by a computing device to cause the computing device to:
receive a file including first and second financial numbers;
compress the second financial number;
determine a link for addressing the first financial number; and
replace the second financial number in the file with the compressed, second financial number and the link.

14. The computer program product of claim 13, wherein the financial numbers are financial card numbers.

15. The computer program product of claim 13, wherein the financial numbers are credit card numbers.

16. The computer program product of claim 13, wherein the program instructions are executable by a computing device to cause the computing device to encrypt the second financial number.

17. The computer program product of claim 13, wherein the program instructions are executable by a computing device to cause the computing device to add, to the file, a notification of obscured financial numbers.

18. The computer program product of claim 13, wherein the program instructions are executable by a computing device to cause the computing device to compress and encrypt the first financial number.
